(19) United States
(12) Patent Application Publication
(10) Pub. No.: US 2025/0029175 A1
(43) Pub. Date: Jan. 23, 2025

(54) DIVERSIFIED SYSTEM SHARED RENTAL DEVICE AND METHOD

(71) Applicant: Hong-Rong LIN, Yilan County (TW)

(72) Inventor: Hong-Rong LIN, Yilan County (TW)

(21) Appl. No.: 18/224,586

(22) Filed: Jul. 21, 2023

(51) Int. Cl. G06Q 30/0645; G06K 7/14; G06Q 10/02

(52) U.S. Cl. CPC G06Q 30/0645; G06K 7/1417; G06Q 10/02; G06Q 2220/00

(57) ABSTRACT

A diversified system shared rental device and method relates to a service and associated system that can turn any vehicle (such as a self-use vehicle) into a rentable vehicle. By means of a “vehicle rentable and networkable module”, all vehicles required to be rented and networked are installed, and the vehicles with rentable capability processed by the vehicle rentable and networkable module are connected to the diversified system shared rental device. Through the control of the diversified system shared rental device, a rental service of the rentable vehicles is provided. A rental platform is provided for completing a renal match operation, so that a general self-use vehicle can be rented and shared at any time in the free time to minimize the idle cost of all the vehicles and create a profit-making model to promote the benefits of the part-time economy.

### BACKGROUND OF THE DISCLOSURE

### Technical Field

The present disclosure relates to a device and method, more particularly relates to a diversified system shared rental device and method that can change any vehicle into a rentable vehicle service and its associated system.

### Description of the Related Art

In the traditional or prior-art vehicle rental markets, there are many technical problems, such as: 1. The traditional rental markets such as iRent in Taiwan, requires a substantial investment in vehicles and the need to replace them every ten years, thus increasing costs and risks. 2. Traditional rental markets around the world require cumbersome verifications of documents and car delivery procedures, thus users waste a lot of time waiting. 3. Traditional rental markets, such as the iRent in Taiwan, cannot overcome the problems of vehicle cleanliness, oil and fluid inspection, tire pressure safety, etc., thus affect the users' use experience and safety.

Therefore, the traditional or prior-art car rental is a shared rental, which cannot turn a self-use car into a rentable state. It is necessary to invest a lot of capital to buy cars, and it is impossible to cooperate with anyone who owns a car in the world for mutual benefit, or to increase the income of a family and an individual, and the traditional or prior-art shared rental car becomes a negative asset and cannot turn a self-use car to make profits in a disguised form, and the traditional or prior-art rental has not gone through the upload via a name-based system and the verification of identity documents or driver's license, so that users cannot rent a self-use car in any place around the world. In addition, the traditional or prior-art shared rental car further needs to face the cumbersome process of car delivery, and car renters are fully responsible for all the cleaning and inspection of the traditional or prior-art shared rental cars, therefore it is necessary to hire personnel to handle the cleaning and inspection, which increases the operating expenses of the car renters. In the traditional or prior-art shared rental, it is not possible to use a SIM card or control chip to rent a self-use car at a rentable and networked state without being limited by its forms.

For example, a first prior art relates to a “System and method for renting smart cars”, which was not invented for self-use vehicles. This prior art does not focus on the invention for self-use cars which cannot be dispatched through a diversified system shared rental device to allocate a vehicle when a car owner is not using the car, or dispatch the car back to the car owner's home for use by his/her family members.

For example, a second prior art relates to a “Method, system and non-temporary computer readable storage media for electric vehicles” which is limited to the use of an electric power driving device of an electric vehicle, such that its use is limited.

For example, a third prior art relates to an “Unattended electric vehicle rental system”, which is mainly to obtain violation information to maintain safety, and are mainly for electric vehicles, so the solutions for traditional fuel vehicles are not considered.

For example, a fourth prior art relates to a “Remote monitoring method and device for rented vehicles”. According to its main technical characteristic is limited to GPS only, it does not introduce SIM cards and other devices, its use is narrow, and it is not possible to establish rentable and networked vehicles for own use. Therefore, it is not possible to provide users with more additional functions other than simple monitoring (e.g. unlocking vehicles by cell phone, sharing content, etc.)

For example, a fifth prior art relates to a “Shared system”, and there is a possibility of falsification of this prior art.

Therefore, the traditional or prior-art shared rental still has various shortcomings, which make them less practical, and where the manufacturers and consumers are eager to break through.

### SUMMARY OF THE DISCLOSURE

In view of the aforementioned shortcomings, it is a primary objective of this disclosure to overcome the shortcomings of the prior art by providing a diversified system shared rental device and method, and the device uses a vehicle, a vehicle rentable and networkable module and a rental platform to carry out the diversified system shared rental method, which includes the steps of: (1) making a vehicle rental request by a user; (2) entering into a diversified system shared rental device; (3) screening a suitable vehicle by the diversified system shared rental device or inquiring and selecting a suitable vehicle by a customer; (4) completing the pairing of a rentable vehicle.

A secondary objective of this disclosure is to provide a diversified system shared rental device and method that uses a vehicle rentable and networkable module to establish a vehicle with a rental capability and a link and connection with the diversified system shared rental device to obtain a rentable and networked vehicle through the vehicle rentable and networkable module, complete a rental matching through the rental platform and provide the control, distribution, operation and management of the rental vehicles.

Another objective of this disclosure is to provide a diversified system shared rental device and method, using the diversified system shared rental device to display a suitable vehicle to users through a rental platform for matching, completing and using a rental; providing any vehicle that is suitable, allowing the establishment of a self-use vehicle that can be rented and networked, letting users rent the vehicle through the rental platform, and completing the rental of the vehicle. Vehicle owners can also confirm the acceptance of the user's rental through the rental platform, thus completing the rental matching operation, providing users with advance reservation or real-time matching with a designated driver, allowing the user to take photos around the vehicle and complete recording the conditions of the vehicle before the diversified system shared rental device provides a rental service (or unlock the vehicle).

A further objective of this disclosure is to provide a diversified system shared rental device and method, which can effectively improve the convenience of use and provide rental and sharing of people's self-use vehicles at any time in their free time, minimizing the idle cost of all vehicles, and establishing a profit model for the self-use vehicles.

This disclosure intends to overcome the following technical problems existing in the traditional or prior-art vehicle rental market. For example, (1) Traditional rental markets, such as iRent in Taiwan, requires heavy investment in purchasing cars and replacing them every 10 years, thus increasing costs and risks; (2) Traditional rental markets around the world require cumbersome document verification and delivery procedures, and users need to spend a lot of time waiting; (3) Traditional rental markets such as iRent in Taiwan cannot overcome the problems of car cleanliness, the inspection of engine oil, automatic transmission fluid, power steering fluid, brake fluid, gasoline, and water in water tank, battery, and windshield wiper, tire pressure safety, etc., which affect the user's experience and safety of driving.

The traditional and prior-art rental is a shared rental, and cannot turn self-use vehicles into a rentable status, and the traditional or prior-art car rental markets need to invest a lot of capital to purchase the vehicles and cannot cooperate with anyone who owns a vehicle worldwide for mutual benefit, and cannot increase the income of families and individuals, the traditional or prior-art shared rental vehicles become negative assets and cannot turn self-use vehicles into profit. In addition, users are unable to rent self-use vehicles anywhere in the world, because there is no real name registration system or driver's license uploading in the traditional or prior-art shared leased vehicles, so that the users have to face the cumbersome process of handing over the vehicles, and the renters are solely responsible for the cleaning and inspection of all vehicles in traditional or prior-art shared leased vehicles. As a result, the renters need to hire someone else to handle the vehicles, thus increasing the renters' operating expenses. In addition, it is not possible for the traditional or prior-art shared rental to use SIM cards and chips to make all vehicles rentable and networkable

For example, the first prior art relates to the “System and method for renting smart cars”, which is not directed to the invention of self-use vehicles, and it is not possible to allocate the vehicle through a diversified system shared rental device when the owner is not using it, or to transfer the vehicle back to the owner's home and provide it to the family for use. The second prior art relates to the “Method, System and Non-Temporary Computer Readable Storage Media for Electric Carriers”, which is restricted to the electric drive device of the electric vehicle and the usage is limited. The third prior art relates to an “Unattended Electric Vehicle Rental System”, which mainly obtains violation information to maintain safety and is mainly used for electric cars, so that it does not consider the solution method for traditional fuel vehicles. The fourth prior art relates to a “Remote monitoring method and device for rented vehicles”, which is limited to GPS only and does not import SIM cards and other devices, and its scope of use is narrow and cannot establish the rentability of self-use vehicles and the use of electric vehicles. Therefore, it is impossible to provide users with more additional functions other than simple monitoring (e.g., unlocking the vehicle by mobile phone, sharing contents, etc.). The fifth prior art relates to a “shared system”, which may be falsified. Therefore, there are various drawbacks in the traditional or prior-art shared rental, which make them much less practical.

To overcome the aforementioned drawbacks and achieve the aforementioned and other objectives, this disclosure provides a diversified system shared rental device, characterized in that the diversified system shared rental device includes:
a plurality of vehicles;
a vehicle rentable and networkable module, connected to the vehicles;
a rental platform, connected to the vehicle rentable and networkable module and the vehicle, and provided for a user to use the service of the diversified system shared rental device; while a vehicle owner can confirm and accept the user's rental through the rental platform to complete a rental matching operation; such that the vehicle rentable and networkable module displays a suitable vehicle through the rental platform for the user to complete pairing and using the rental service.

Wherein, the diversified system shared rental device establishes the vehicle with a rental capability through the vehicle rentable and networkable module and provides a rental control of the vehicle by linking and connecting the rentable and networked vehicle obtained through the vehicle rentable and networked module to complete the rental matching through the rental platform and provide the rental control, distribution, operation and management of the vehicle.

Wherein, the rental platform of this disclosure is implemented by a method including but not limited to App, website, WeChat applets, desktop applications, cross platform framework, Alipay or LINE.

Wherein, the vehicle of this disclosure includes but not limited to cars (such as fuel cars, hybrid cars, electric cars, etc.), aircrafts (such as flying cars, flying fuel cars, flying hybrid cars, flying electric cars, etc., motorcycle, bicycle, airplane, ship/boat, public transportation means (such as bus, subway, tram, etc.), personal transportation means (such as wheelchair, scooter, skateboard, etc.), transportation means (such as trailer, truck, etc.), unmanned vehicle (such as auto-driving car, drone, etc.), railway transportation (such as train/high-speed rail/subway, etc.)

To provide a technical measure of solving the problems of the prior art and achieving the aforementioned objectives, this disclosure provides a diversified system shared rental method, characterized in that a diversified system shared rental device includes a plurality of vehicles, a vehicle rentable and networkable module and a rental platform for carrying out the diversified system shared rental method, including the steps of:
(1) making a vehicle rental request by a user;
(2) entering into the diversified system shared rental device;
(3) screening a suitable vehicle by the diversified system shared rental device or inquiring and selecting a suitable vehicle by a customer; and
(4) completing the pairing of a rentable vehicle.

Wherein, the vehicle of this disclosure is turned into a rentable and networkable vehicle by a method including the steps of:
(1) equipping the vehicle with a camera device with the functions of networking, connecting, sensing and scanning a barcode and a QR code; and a monitoring device;
(2) connecting the equipment installed on the vehicle to the diversified system shared rental device to complete a link; such that the vehicle has a control means, and can be rented and networked.

Wherein, the networking, connecting, sensing, photographing and monitoring device adopted by this disclosure to achieve the step (1) of the method includes but not limited to a chip, a SIM card, an eSIM, a Soft SIM, a smart card, a mobile device built-in network connection, a vehicle network module, a GPS chip, a GLONASS chip, a Galileo chip, a BeiDou chip, a Starlink terminal device, an L-Band converter, a Software-defined radio (SDR), a GNSS chip, camera device, a 360 degree panoramic camera, a 360 degree surround sound recording microphone, an AR/VR technology combined with unmanned remote control device, a vehicle speed sensor, a rotation speed sensor, an oil level sensor, a coolant temperature sensor, an oxygen sensor, a tire pressure monitoring system, a stability control system, a brake system monitoring system, a battery management system, and a charging management system. This allows any vehicle to send signals autonomously, connect to the vehicle of the aforementioned equipment, and obtain relevant information of the vehicle directly through that equipment after connecting and linking through the shared rental device of the diversified system.

Wherein, the technical measure for the networking, linking, and sensing function of this disclosure includes but not limited to Wi-Fi, Bluetooth (Bluetooth), Zigbee, LoRa, Near Field Communication (NFC), 5G, and 4GLTE.

Wherein, the car rentable and networked module of this disclosure makes the vehicle rentable and networkable by a method including the steps of:
(1) equipping the car with a chip or a device that can sense NFC and connect to the network, and a camera device that can scan any barcode and QR code; and
(2) connecting the device installed to the car with the diversified system shared rental device to complete the link; such that the vehicle can use the camera device with the NFC function and the capability of scanning any barcode and QR code to allow the rentee to obtain the vehicle's operation functions including but not limited to unlocking, opening the lock and starting the vehicle by scanning the barcode and QR code to complete the authentication, and to allow the diversified-system shared rental device to have the control means to control the vehicle for rental by connecting to the diversified-system shared rental device through the network, so that the vehicle can be rented and networked.

Wherein, the diversified system shared rental device of this disclosure manages all rentable vehicles, including but not limited to repair/maintenance management, violation management, insurance management, positioning management, accident management, evaluation management, dispatch management, recovery management, and reminder management.

Wherein, the implementation method of the rental platform of this disclosure includes but not limited to App, website, WeChat applet, desktop application, cross platform framework, Alipay or LINE.

Wherein, the rental platform of this disclosure provides a login means to the user or the vehicle owner, and the service usage and account creation method include username and password, social media communication software login, email verification code, SMS verification code, fingerprint recognition, face recognition, retina recognition or voice recognition; and the user provides information including but not limited to mobile phone number, email, identity information (such as identity card, passport, driver's license, international driver's license), payment method (such as global credit card, electronic payment, third-party payment, etc.), to avoid data tampering by blockchaining technology, create the user's digital identity authentication, and complete registering an account to use the rental platform.

Wherein, the rental platform of this disclosure assists the user to rent a vehicle and the vehicle owner to use the associated service for renting out a vehicle through the following features/functions including but not limited to registration and authentication, car search and reservation, user vehicle unlock/use, pricing method, payment, order management, socialization and promotion, wallet and vehicle owner management assistance.

Wherein, the diversified system shared rental device of this disclosure can be implemented by the rental platform with separate independent application programs for the renter and user; and the renter application program is provided for the renter to manage the vehicles, set a rental plan, accept a rental request, etc., while the user application program is provided for the user to search, reserve, pay, pick up and return the vehicle, thus establishing individual data of the renter and user.

Wherein, the diversified system shared rental device of this disclosure is an unmanned diversified system shared rental device based on a rental method of an unmanned driving technology, and the diversified system shared rental device allow users to reserve and complete the operation such as picking up, returning and driving the car.

Wherein, the diversified system shared rental device of this disclosure provides users with advance reservations or instant matching with a designated driver through the rental platform.

Wherein, the rental platform of the diversified system shared rental device of this disclosure may also provide customized options for rental services; the vehicle owner may select the available services in accordance with local regulations, thus the rental platform of the diversified system shared rental device of this disclosure will instruct the users to meet the requirements in response to such requirements before the users can rent vehicles.

Wherein, the vehicles established by the vehicle rentable and networkable module of the diversified system shared rental device of this disclosure can have a network sharer effect through vehicle network sharing and signal sharing, such that the vehicle owner can use the network fee as another means of income; and it can also be applied for information transmission (such as serving as a mobile signal station at war, transmitting war information, etc.)

Wherein, the vehicles established by the vehicle rentable and networkable module of the diversified system shared rental device of this disclosure can be equipped with a network device or a GPS device to form the Internet of Vehicles, thus improving the performance of the vehicles, safety and automatic driving determination ability, while building big data to improve traffic jam. In the future, these data can be provided to vehicle manufacturers to use or improve traffic jam by traffic light management optimization, so as to improve the efficiency and safety on the road of a trip.

Wherein, the diversified system shared rental device of this disclosure uses blockchain decentralization to protect data and prevent data tampering, and creates digital identity authentication, which provides blockchain users and vehicle owners identity authentication including but not limited to passport, driver's license, electronic identity information, etc., thus avoiding identity tampering, and it can also be applied to blockchain airline tickets for immigration, custom clearance, and other operations.

Wherein, the user vehicle unlock/use of the rental platform of the diversified system shared rental device of this disclosure can provide a payment means including but not limited to QR code, barcode, and pay code through a global blockchain wallet payment system for the cross-country use of wallet function to avoid the situation that the user is limited by cross-country credit card and payment.

Wherein, the user vehicle unlock/use of the rental platform of the diversified system shared rental device of this disclosure can use the function including but not limited to NFC, Bluetooth, etc., the proximity sensing function of a user device (such as a mobile phone) in an application including but not limited to housing keys, car keys, amusement park tickets, exhibition tickets, restaurant reservation tickets, lecture tickets, concert tickets, airline tickets, etc. and integrate the rental service into the overall key integration application of the associated service.

Wherein, the diversified system shared rental device of this disclosure can be applied to the diversified system shared rental device and expanded to unmanned/manned courier applications, as well as to retrieve and return vehicles and identify users through new technologies including but not limited to metaverse, Web3.0, 6G, AR, VR, MR, LEO satellite communication technology, long-range (e.g., sea carrier, flight carrier, etc.) communication and network relay technology, 3D, XR, multi-view angle, virtual-reality integration, AI sensing, AI recognition, immersive experience, etc. to improve the efficiency and safety of the diversified system shared rental device.

Wherein, the user vehicle unlock/use of the rental platform of the diversified system shared rental device of this disclosure can be implemented through any of the described methods (such as: App, etc.) to establish digital keys, and can be established according to the needs of a plurality of digital keys with the similar effect of the primary key and secondary key of the general cars, and the users can share the digital key with a target object through the rental platform to enhance the convenience of the rental service.

Compared with the effects of the prior art, the diversified system shared rental device of this disclosure is achieved by using the vehicle, the vehicle rentable and networkable module and the rental platform to carry out the diversified system shared rental, which includes the steps of: (1) making a vehicle rental request by a user; (2) entering into the diversified system shared rental device; (3) screening a suitable vehicle by the diversified system shared rental device or inquiring and selecting a vehicle by a customer; (4) completing the pairing of the rentable vehicle. The vehicle rentable and networkable module is used to establish the vehicle with a rentable capability, obtain the connection, and link of the vehicle that can be rented and networked through the vehicle rentable and networkable module, complete the rental matching through the rental platform and provide the rental control, distribution, operation and management of the vehicle. The diversified system shared rental device displays the suitable vehicle through the rental platform for the user to complete the pairing and use the rental service, provides a rental service applicable for any of the vehicles, and allows a self-use vehicle to be rentable and networkable, such that users can rent the vehicle through the rental platform. The vehicle owner can also confirm and accept the user's rental request through the rental platform, so as to complete the rental matching operation, and provide the users with advance reservation or instant matching of a designated driver. The users need to take the photo of the surrounding of the vehicle to record the vehicle conditions, before the diversified system shared rental device will provide the rental (or unlock the vehicle), thus effectively enhancing its ease of use and allowing people to rent and share the vehicle for their own use at any time in their free time, minimizing the idle cost of the vehicle and establishing its profit model, which greatly expands the utilization of the industry and is innovative and inventive.

### BRIEF DESCRIPTION OF THE DRAWINGS

FIG. 1 is an architectural diagram of a diversified system shared rental device of this disclosure;

FIG. 2 is a flow chart of a rental operation method carried out by a diversified system shared rental device of this disclosure;

FIG. 3 is a flow chart of making a vehicle rentable and networkable in accordance with this disclosure; and

FIG. 4 is a flow chart of making a car rentable and networkable in accordance with this disclosure.

### DESCRIPTION OF THE PREFERRED EMBODIMENTS

The objectives, technical contents and features of this disclosure will become apparent in the following detailed description of the preferred embodiments with reference to the accompanying drawings. It is noteworthy that the drawings used in the specification and subject matters of this disclosure are intended for illustrating the technical characteristics of this disclosure, but not necessarily to be drawn according to actual proportion and precise configuration. Therefore, the scope of this disclosure should not be limited to the proportion and configuration of the drawings.

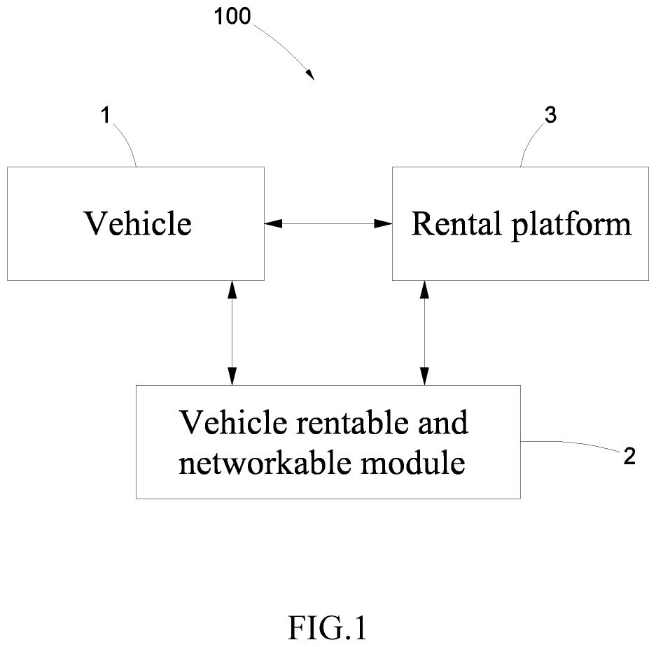

With reference to FIGS. 1 to 4 for the architectural diagram of a diversified system shared rental device, the flow chart of a rental operation method carried out by the diversified system shared rental device, the flow chart of making a vehicle rentable and networkable, and the flow chart of making a car rentable and networkable in accordance with this disclosure respectively, the diversified system shared rental device 100 of a preferred embodiment as shown in FIG. 1 includes a plurality of vehicles 1, a vehicle rentable and networkable module 2, and a rental platform 3.

The vehicles 1 includes but not limited to cars (such as fuel cars, hybrid cars, electric cars, etc.), flying vehicles (such as flying cars, flying fuel cars, flying hybrid cars, flying electric cars, etc.), motorcycles, bicycles, airplanes, ships/boats, public transportation means (such as bus, subway, tram, etc.), personal transportation means (such as wheelchairs, scooters, skateboards, etc.), transportation means (such as trailers, trucks, etc.), unmanned vehicles (such as auto-driving cars, drones, etc.), railway transportations (such as train/high-speed rails/subways, etc.).

The vehicle rentable and networkable module 2 is connected to the vehicle 1 for turning the vehicle 1 rentable and networkable for the establishment of the vehicles 1 with a rental capability.

The rental platform 3 is connected to the vehicle rentable and networkable module 2 and the vehicle 1, allowing the users to use the service of the diversified system shared rental device 100; while the owner of the vehicle 1 can confirm the acceptance of the user's rental through the rental platform 3 to complete the rental matching operation; and the vehicle rentable and networkable module 2 is provided for displaying the suitable vehicle 1 through the rental platform 3 for the user to complete matching and using the rental service.

The diversified system shared rental device 100 of this disclosure establishes the vehicle 1 with a rental capability through the vehicle rentable and networkable module 2, obtains the connection and link of the vehicle 1 that can be rented and networked through the vehicle rentable and networkable module 2, and provides a system for the rental control, distribution, operation and management of the vehicle 1.

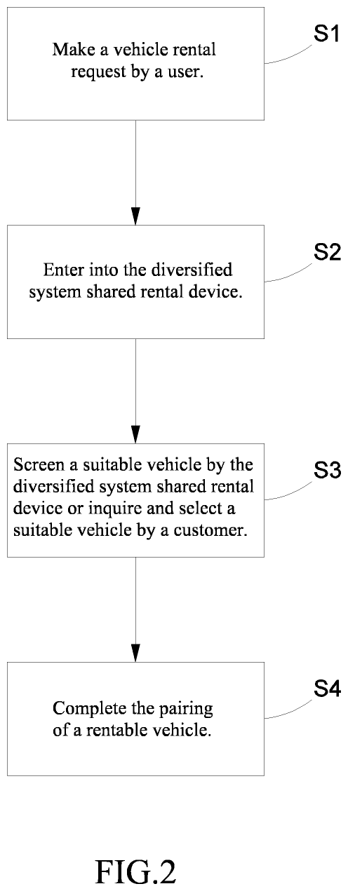

With reference to FIG. 2 for the flow chart of a rental operation method carried out by the diversified system shared rental device of this disclosure, the method is carried out by the diversified system shared rental device 100 which includes a plurality of vehicles 1, a vehicle rentable and networkable module 2 and a rental platform 3, and the method includes the steps of:
(S1) making a vehicle rental request by a user;
(S2) entering into the diversified system shared rental device, wherein the rental request is entered in or sent to the diversified system shared rental device 100;
(S3) screening a suitable vehicle by the diversified system shared rental device or inquiring and selecting a vehicle by a customer, wherein the diversified system shared rental device 100 displays the suitable vehicle 1 through the rental platform 3 for users, and selects the suitable vehicle 1 by a method including but not limited to screening the suitable vehicle 1, or the rental platform 3 provides users the functions of searching, finding and checking of the vehicle 1 to allow the users to complete renting the available vehicle 1; and
(S4) complete matching the rentable vehicle, wherein after the matching of the rentable vehicle for the users, the users can use the rented vehicle 1.

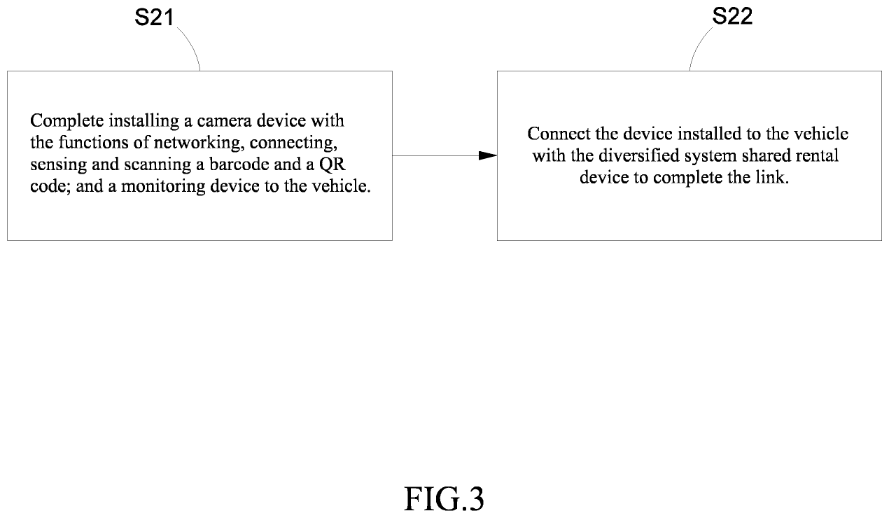

With reference to FIG. 3 for the flow chart of making a vehicle rentable and networkable in accordance with this disclosure, the method for achieving that the vehicle can be rented and networked includes the following steps:
(S21): Equip the vehicle with a device including but not limited to a camera device or monitoring device that can connect and link to the network, and sense and scan barcodes and QR codes; and
(S22): Connect and link the device installed to the diversified system shared rental device 100.

Therefore, the vehicle can be rented and networked, and has a control means.

The connecting, linking, sensing, photographing and monitoring devices of this disclosure include but not limited to a chip, SIM card, eSIM, Soft SIM, smart card, mobile device built-in network connection, vehicle network module, GPS chip, GLONASS chip, Galileo chip, BeiDou chip, Starlink terminal device, L-Band converter, Software-defined radio (SDR), GNSS chip, camera device, 360 degree panoramic camera, 360 degree surround sound recording microphone, AR/VR technology combined with unmanned remote control device, vehicle speed sensor, rotation speed sensor, oil level sensor, coolant temperature sensor, oxygen sensor, tire pressure monitoring system, stability control system, brake system monitoring system, battery management system, or charging management system, so that any vehicle can send out signals autonomously and connect the diversified system shared rental device 100 of this disclosure with the vehicle 1 of the aforementioned device. After connection, related information of the vehicle 1 can be obtained directly through the device.

In the aforementioned devices: 1. Chip: The chip has the function of storing information and can store the user's information, such as mobile phone number, mobile network access node name, network key value, short message; 2. SIM Card: The subscriber identity module card (SIM card) is a chip card generally used in mobile phones, tablet PCs, mobile routers, and other mobile devices for storing related information of the device user including a device user identity, network connection permit, etc. By installing different SIM cards, the users can switch between different network operators to access different network services. In addition, the SIM cards can also be used to encrypt users' data and phone calls to improve the security of communication; 3. eSIM: The eSIM is an embedded SIM that directly connects a device to the mobile network without requiring a physical SIM card; 4. Soft SIM: The soft SIM is similar to the eSIM, but it does not requires any hardware, but uses a safety software to simulate the SIM card to provide the capability of connecting to the mobile network; 5. Smart Card: The smart card has the capability of storing and processing data as well as using the technology of the SIM card such as GSM to connect to the mobile network; 6. Mobile Device Built-in Network Connection: Some mobile devices such as tablet PCs and laptops have the built-in network connection that can connect to Wi-Fi or mobile network to provide Internet connectivity; 7. Vehicle Network Module: Some cars are equipped with a specialized vehicle network module, and can use the SIM card to connect to the mobile network, so as to provide Internet connectivity to the cars; 8. GPS Chip: The GPS chip is a microchip with a GPS positioning capability that can receive signals transmitted from a GPS satellite; 9. GLONASS Chip: GLONASS is a Russian satellite system that has a GPS-like positioning function, and the GLONASS chip is capable of receiving signals from the GLONASS satellite for positioning; 10. Galileo Chip: Galileo is a satellite system launched by the European Union, which also has the GPS-like positioning capability and the Galileo chip can receive signals from Galileo satellites and perform positioning; 11. BeiDou Chip: BeiDou is a satellite system launched by China which also has the GPS positioning function and the BeiDou chip can receive signals from BeiDou satellites to perform positioning; 12. Starlink Terminal Device: SpaceX Starlink is a satellite communication network that provides a high-speed network connection and the Starlink terminal device can be used to receive satellite signals, and such terminal device includes devices such as Dishy McFlatface, etc.; 13. L-Band Converter: The L-band converter is a converter that can convert L-band signals into signals of other bands to receive various satellite communication signals; 14. Software-Defined Radio (SDR): The SDR is a software-defined radio which can be set by software to receive and transmit various radio signals including the satellite communication signals; 15. GNSS Chip: The GNSS chip generally can receive GPS, GLONASS, Galileo, BeiDou and other satellite positioning signals and can be used to receive satellite communication signals; 16. Camera Device: The camera device is a device that can scan barcodes and QR codes and it includes but not limited to a built-in camera of a smart phone or a tablet PC, a scanner, an unmanned camera, a vehicle camera with the function of scanning the barcodes and QR codes; 17. 360-Degree Panoramic Camera: It includes cameras such as Insta360, GoPro Max, Ricoh Theta, etc.; 18. 360-degree surround sound recording microphone: It includes microphone such as Zoom H3-VR, Sennheiser AMBEO, etc.; 19. AR/VR Technology Combined with Unmanned Remote Control Device: It includes the VR/AR head-mounted device such as Oculus, HTC, Sony, etc. of an autopilot system such as Waymo, Tesla, etc.; 20. Vehicle Speed Sensor: This sensor measures the speed of a vehicle (car); 21. Rotation Speed Sensor: This sensor is used to measure the rotating speed of an engine; 22. Oil Level Sensor: This sensor is used to measure the amount of fuel in the fuel tank; 23. Coolant Temperature Sensor: This sensor is used to measure the temperature of engine cooling fluid; 24. Oxygen Sensor: This sensor is sued to measure the oxygen content in exhaust gas discharged from an engine; 25. Tire Pressure Monitoring System: This system is used to monitor tire pressure; 26. Stability Control System: This system is used to monitor the stability of a vehicle (car) and take necessary actions, if needed, to avoid loss of control of the vehicle (car); 27. Brake System Monitoring System: This system is used to monitor the operating conditions of a vehicle (car) braking system; 28. Battery Management System: This system is used to monitor the charging status of a vehicle battery, the battery temperature, and other parameters; 29. Charging Management System: This system is used to monitor the voltage, current and other parameters during the vehicle charging process.

Therefore, any vehicle can send out signals autonomously and connects the “diversified system shared rental device 100” of this system to the vehicle 1 of the aforementioned device. After the connection, related information of the vehicle 1 can be obtained directly through the device.

The technical measures of the networking, connecting and sensing functions of this disclosure include but not limited to Wi-Fi, Bluetooth, Zigbee, LoRa, Near Field Communication (NFC), 5G, 4GLTE, PHS digital mobile communication technology; wherein 1. Wi-Fi: It is a wireless networking technology which can connect a device to the Internet or local area network via a wireless transmission; 2.Bluetooth: It is a short-range wireless communication technology, which can connect devices by a direct communication, such as the connection between a mobile phone and a Bluetooth earphone; 3. Zigbee: It is a low-power wireless communication protocol, which is commonly used for the connection between Internet of things (IoT) devices; 4. LoRa: It is a long-distance low-power wireless communication technology, which is suitable for the long-distance communication occasions required by the Internet of things (IoT); 5. Near Field Communication (NFC): It is a short-range wireless communication technology which can connect devices by a direct communication, such as the payment between a smart phone and POS machine; 6. 5G: It is a 5G mobile communication technology with faster speed and lower latency, which is suitable for the occasions of high-speed data transmission and Internet of things; 7. 4GLTE: It is a 4G mobile communication technology, which provides a high-speed network connection, and is suitable for the applications such as high definition video streaming, online game and cloud service.

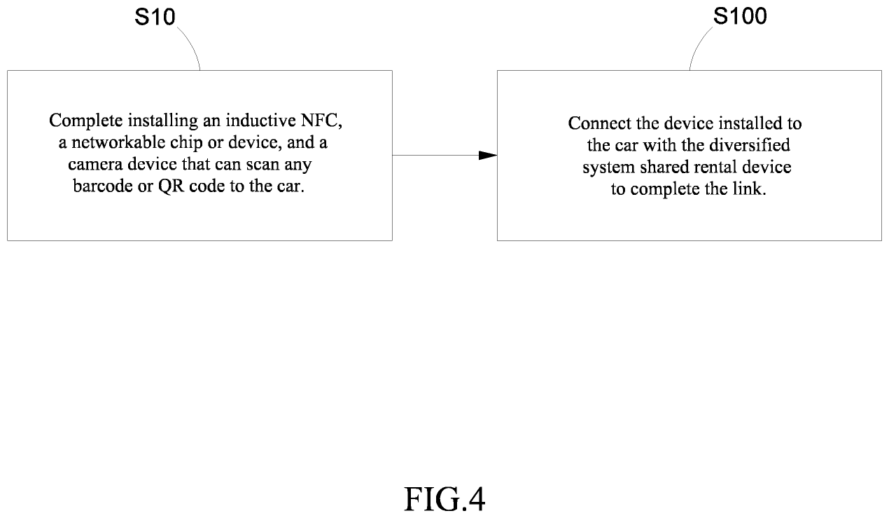

With reference to FIG. 4 for the flow chart of a method of making a vehicle rentable and networkable, this disclosure uses a car (such as a fuel car, a fuel-electric vehicle, a pure electric vehicle, etc.) as an embodiment, and the method for the vehicle rentable and networkable module 2 to make the car rentable and networkable in accordance with this disclosure is as follows.
(S10): Equip the car with a chip or device that can sense NFC, connect to the network, and a camera device that can scan any barcode and QR code.
(S100): Connect the device installed to the car with the diversified system shared rental device 100.

Therefore, the car can use the camera device with the function of sensing NFC and scanning barcodes and QR codes to allow a rentee to scan the barcode and QR code in order to complete authentication and obtain the operation functions of the car including but not limited to unlocking, opening the lock, and starting the car, and connect with the diversified system shared rental device 100 online, such that the diversified system shared rental device 100 can provide a rental control means of the car and make the car rentable and networkable.

In FIG. 2, the diversified system shared rental device 100 of this disclosure will also manage all rentable vehicles 1 including but not limited to the inspection/maintenance management, violation management, insurance management, positioning management, accident management, evaluation management, dispatch management, recovery management, and reminder management, and these managements are described in details below:
1. Inspection/Maintenance Management: The diversified system shared rental device inspects the vehicle including the parts of braking system, electric appliance system, suspension system, etc. to ensure the safe operation of the vehicle through the aforementioned monitoring equipment. The system regularly sends maintenance requests for the vehicle to ensure that it is in good operating conditions.
2. Violation Management: The diversified system shared rental device monitors the violations of the vehicle (through the aforementioned video equipment to identify violations) and keep the evidence to ensure the safety and stability of the vehicle on the road.
3. Insurance Management: The diversified system shared rental device insures the vehicle platform and update the vehicle information to the rental platform for vehicle owners and users to check to ensure the safety of vehicles and users.
4. Positioning Management: The diversified system shared rental device carries out the record management and tracking of the vehicle location information for the vehicle positioning (through the aforementioned GPS chip).
5. Accident Management: The diversified system shared rental device monitors the driving conditions of the vehicle, and in the event of an accident, the vehicle owner and user will be notified through the rental platform to handle the accident and clarify the attribution of responsibility.
6. Evaluation Management: The diversified system shared rental device evaluates the vehicle (based on the supporting information, such as photo, driver's license, history maintenance record, insurance record, etc. provided by the vehicle owner). By the evaluation (based on different photos and data grading evaluations), the vehicle is ensured to be in a suitable rental condition.
7. Dispatch Management: The diversified system shared rental device dispatches vehicles of the vehicle platform (through the dispatch such as autopilot, the automatic return of the vehicle to a positioning point, et.) to timely satisfy users' rental requirement and vehicle dispatch.
8. Recovery Management: After the diversified system shared rental device obtains the notice of an end of a vehicle rental, the aforementioned monitoring device will check the car conditions and confirm that the vehicle is in a suitable condition for rental by the vehicle owner or use by the next user.
9. Reminder Management: The diversified system shared rental device performs a reminder management of the vehicle platform through the aforementioned monitoring device, and the reminder management includes but not limited to car maintenance, repair, insurance, annual inspection, etc. to ensure that the vehicle is in a safe condition.

With reference to FIG. 1 and the aforementioned rental platform 3 of this disclosure, the rental platform 3 is connected to the vehicle rentable and networkable module 2, which provides users with the ability to use the service of the diversified system shared rental device 100 through various implementations. At the same time, the owner of the vehicle 1 can also confirm the acceptance of the user's rental through the rental platform 3, thus completing the rental matching operation, and the rental platform 3 is implemented by a method including but not limited to App, website, WeChat applet, desktop application, cross-platform framework, Alipay or LINE, wherein 1. App: 1.App: Through the native Apps of iOS and Android, users can download the native apps of the rental platform 3 and install them on their own mobile phones; 2. Website: Through the web platform, a web version of the rental platform 3 is created and users can access the website through the browsers; 3. WeChat Applets: Through an applet on the WeChat platform, users can use the rental platform 3; 4. Desktop Applications: Through the desktop applications platform, a desktop version of the rental platform 3 is developed, and users can download and install the desktop applications of the rental platform 3 to their computers for use; 5. Cross Platform Framework: Native applications for iOS and Android are developed using a cross platform framework such as React Native and Flutter, allowing users to download the native applications of the rental platform 3 and install them on their own phones, as well as use them on the web; 6. Alipay: Through Alipay, a third-party payment platform in China, the rental platform 3 is built on top of Alipay and made available to users. At the same time, Alipay provides credit rating and credit guarantee services to enhance the security and trust of the rental platform 3; 7.LINE: Through LINE, a social media platform that allows instant communication, a dedicated LINE account is created to set up the rental platform 3 and to enhance the convenience and ease of use of the rental platform 3, and we can make reservations, payments and communications through LINE. LINE will also provide services such as insurance and roadside assistance to enhance the security and trust of the rental platform

This disclosure uses a car (such as a fuel car, a fuel-electric vehicle, a pure electric vehicle, etc.) as an embodiment and can provide a verifiable means of unlocking the car including but not limited to the means of confirming the license plate number and providing a verification code by an input device to confirm that the car is the one called by the user before the car can be unlocked when the car arrives, or the means of unlocking the car before getting into the vehicle (to prevent unmanned and manned vehicles from arriving early and the user gets into a wrong vehicle and preventing intentional people to open the car door and get into the car for practical pranks or conduct other dangerous incidents to the users and their designated drivers). The car can be set to the functions including but not limited to locking all car doors automatically when getting into the car, i.e. the user can only open the door from the inside, so that the doors cannot be opened arbitrarily by someone outside the car and who is not the user or who shares the digital key (to improve security), and the user can control the door locking or unlocking by the mobile phone, and prevent pranks and robberies. In addition, when an accident with strong impact is detected or encountered and the airbags are triggered, all car doors are unlocked automatically to facilitate rescue.

This disclosure uses a car (such as a fuel car, a fuel-electric vehicle, a pure electric vehicle, etc.) as an embodiment and a backstage is provided for controlling the car renter's vehicle and its speed limit, locating its position, as well as providing a camera view, and unlocking the locked doors, which can be used for car thefts or used by the police and public agencies to handle the case. Through the backstage, the car can also be controlled to remain locked, inaccessible and inoperable outside a specific time, and keeps the record of use to protect the information security.

In this disclosure, the rental platform 3 adopts a method to provide a login method to the user or owner of the vehicle 1, and the login method for using the service and creating the account includes username and password, social media communication software login, email verification code, SMS verification code, fingerprint recognition, face recognition, retina recognition or voice recognition; and the user provides information. including but not limited to mobile phone number, email, identity information (such as identity card, passport, driver's license, international driver's license), payment method (such as global credit card, electronic payment, third-party payment, etc.) in order to avoid data tampering through a blockchain technology and the establishment of a user's digital identity authentication, and complete registering to create an account in order to use the rental platform.

In this disclosure, the method of using the service and creating the account of the rental platform 3 includes 1. Username and Password: Users log in the rental platform 3 by entering the username and password set during registration; 2. Social Media Communication Software Login: Users log in the rental platform 3 by using a social media and communication software account, including but not limited to Facebook, Google, Twitter, WeChat, Alipay, LINE and all other existing and future social media and communication software accounts; 3. Email Verification Code: Users need to enter their email address when registering, the system will send a verification code to the email address and then the users enter the verification code to log in the rental platform 3; 4. SMS Verification Code: Users enter the mobile phone number set during registration, and then the system will send a verification code to the mobile phone with the set mobile phone number, and the users enter the verification code to log in the rental platform 3; 5. Fingerprint Recognition: Users can use the fingerprint recognition function of any device (such as a mobile phone, a tablet PC, etc.) for the login; 6. Face Recognition: Users can use the face recognition function of any device (such as a mobile phone, a tablet PC, etc.) for the login; 7. Retina recognition: Users can use the retina recognition function of any device (such as a mobile phone, a tablet PC, etc.) for the login; 8. Voice Recognition: Users can use the voice recognition function of any device (such as a mobile phone, a tablet PC, etc.) for the login; and the users provide information including but not limited to mobile phone number, email, identity information (such as identity card, passport, driver's license, international driver's license), payment method (such as global credit card, electronic payment, third party payment, etc.) in order to avoid data tampering by blockchain technology, create a user's digital identity authentication, and register to create an account, in order to use the rental platform.

The rental platform 3 of this disclosure with the following features and functions assists users to rent and use rental associated services provided by the owner of the vehicle 1, and these features and functions include but not limited to the following:
1. Registration and Identity Authentication: (1) The user obtains the use of the rental platform according to the aforementioned embodiment of the rental platform and registers an account for the use; (2) The user uses its ID card, passport number, face recognition, etc. for real name authentication and uploads its ID card and driver's license to meet regulatory requirements; (3) The user binds including but not limited to global credit cards, electronic payments and third-party payments as payment methods; (4) The rental platform uses a test swipe to verify the successful binding of the payment method, and after the binding is verified to be successful, the subsequent rental consumption details and electronic invoice will be sent to the user's contact means; (5) User's digital identity authentication is established to avoid data tampering through blockchain technology.
2. Car Search and Reservation: (1) Users can use a built-in map or an external map application program to search for a car or use screening conditions to find a car that meets the users' requirements; (2) The users makes a reservation of a vehicle, and then use the built-in map or external map application program to go to the location of the car and rent the car; (3) Anti-tampering mechanism: Users take photos of the car to record the car conditions before the diversified system shared rental device provides the rental service (or unlock the car), thus providing evidence to the attribution of responsibility in the event of a dispute. At the same time, this system is set up to avoid taking pre-recordings, and users must take pictures of the car on site to avoid falsification problems; (4) Built-in Score Rating System: If the user's score falls below a certain value, the rental platform will suspend the user's right of use.
3. User Vehicle Unlock/Use: (1) Car Key Function: A car is used for example, and the car key function can be realized through the rental platform (such as a mobile phone app) by clicking on the functions including but not limited to opening car door, closing car door, finding car horn, turning on headlight, turning on double warning light, starting the car, etc.; (2) QR code Car Key Function: A car is used for example, a QR code of the car key is generated when renting a car, users can open or start the car by scanning the code, and can control the functions of finding the car horn, turning on headlights and double warning lights, locking the car door to return the car, locking the car door during the rental period and other functions through the implementation of the rental platform (such as a mobile phone app); (3) NFC Sensing Function: A car is used for example, and a sensor can be used to unlock the car, lock the car, start the car, etc. by linking the mobile phone NFC sensing function;
4. Pricing method: Pricing is based on the global rental market pricing of individual vehicles and local rental market pricing; vehicle owners may also set their own pricing, or set the price based on the fuel cost per kilometer (or tram tariff).
5. Payment: (1) Payment of rental fee can be made through systems including but not limited to global credit card, electronic payment, third party payment, etc.; (2) Identity is verified through a face selfie provided by the user; 3. Built-in wallet is used for storing prepayment, which should be used by a user without the aforementioned payment method; (4) Rental fee and related payments are deducted directly from the user's wallet after the rental is completed.
6. Order Management: (1) Users can check the history of orders and the contact information (including phone number, social account, email, etc.) of the vehicle owner; 2. If a user loses something on the vehicle, the user can contact the vehicle owner through the application to retrieve the lost item.
7. Social and Promotion: (1) 1. Built-in inbox is provided for receiving the information of real-time special offers, cooperative advertising promotions, local popular events, food, clothing, housing, entertainment and medical push messages; (2) Built-in forum is provided for users to share and discuss food, clothing, housing, transportation, entertainment and medical services; (3) Built-in chat system is provided for carrying out text communication and real-time voice calls, as well as sending photos and videos, and this system provides a conduit for sharing rides between users or going out together for a trip, renting cars in groups, and sharing fuel costs; (4) Built-in links to external map systems (such as Google Map), parking information maps of various countries, charging and parking information maps, gas station information, hotel and lodging information, food and attraction information, medical information, emergency rescue phone numbers and towing service hotlines and information, etc. are provided for renters to give advice to the rentees on the needs of cross-country services; (5) Built-in interface is provided for sharing and authorizing the use of global major social media platforms and applets; (6) Built-in referral benefit offer function is provided for referrers and referees with an incentive mechanism for customized offers and products through referral sharing. In addition, the benefits can be stored and managed in coupons form in the user account.
8. Wallet: (1) Built-in wallet can be used for storing prepayments, receiving payments and withdrawing refunds, etc.; (2) Users can use the wallet in any country and pay the transaction handling fee at the prevailing rate through a global blockchain wallet payment system.
9. Vehicle Owner Management Assistance: (1) It reminds vehicle owners to have maintenance and repair of the vehicle regularly. At the same time, through the built-in vehicle inspections including but not limited to the inspections of car age, mileage, insurance, right of way, vehicle status, ticket status, fuel status, selected oil tip (such as 92 unleaded gasoline, 95 unleaded gasoline, 98 unleaded gasoline, premium gasoline, diesel, gas, hydrogen), fuel and power remaining volume and replenishment tips, tire pressure display, recommended tire pressure value are displayed etc.; (2) The vehicle owners and users are notified of an accident in a timely manner and provided with the information with regard to the attribution of responsibility through the aforementioned device monitoring.

This disclosure further has the following features and applications:
1. Applications Independence of Rental Platform: The diversified system shared rental device 100 of this disclosure can be implemented through the rental platform 3, and individual applications are independent to the renters and users. The renter application program is provided for the renters to manage vehicles, set rental plans, accept rental requests, etc., and the user application program is provided for the users to search, reserve, pay, pick up, and return vehicles; thus, individual data of the renters and users such as which cars and vehicles are more popular and when the rental volume is the highest, are established respectively in order to optimize business, improve service quality and satisfaction, and further attract more consumers.
2. Unmanned Diversified System Shared Rental Device: The unmanned diversified system shared rental device adopts a rental method based on unmanned driving technology; the diversified system shared rental device 100 allows users to make reservation for an unmanned car, and completes the operations of picking up, returning, and driving the car through the unmanned driving technology; and the main features of the system include but not limited to: (1) Use of unmanned driving technology: the users can autopilot the car to a designated location for pick-up and drop-off services, and automatically return the car to the parking location to wait for the next booking; (2) Interruption of the Autopilot Service at Any Time: users can interrupt unmanned driving service at any time and switch to manual driving mode to improve driving safety; (3) Reservation Service: Users can autopilot the car, including selecting the type of cars, time, location and other reservation information; (4) Safety Protection Measures: Safety protection can be achieved through the introduction of the safety monitoring system, early warning system, emergency braking system, etc.; (5) Autonomous Maintenance and Management: The autonomous maintenance and management mode, including automatic vehicle inspection, automatic charging, automatic car washing and other services, is adopted; thus the system provides another example of implementation, reducing the wear and tear and maintenance costs of the vehicles for owners, and reducing the distribution costs of rented vehicles and improving safety.
3. Matching of Designated Driver: The diversified system shared rental device 100 of this disclosure uses a designated driver matching system to provide users with advance booking or instant matching of designated drivers through the rental platform 3. Taking a car for example, the users can designate a male or female driver, and make a note or message regarding the trip content to the designated driver. The designated driver may also designate users including but not limited to men, women, pet carriers, smokers, etc., and may also refuse users including but not limited to those drinking lots of alcohol, etc. If the designated driver sets an option of refusing service, the rental platform will ask the user to disclose information. At the same time, when the designated driver picks up the car, the system will record and videotape the whole process of the vehicle through the vehicle rentable and networkable module to ensure that all four parties (the platform, designated driver, vehicle renter, and user) can clarify the disputed items and restore the incidence.
4. Customized options of Rental Business Content: The rental platform 3 of the diversified system shared rental device 100 of this disclosure also can provide a customized option for the rental; the owner of the vehicle 1 can select a service item in accordance with local regulations; so that the rental platform 3 of the diversified system shared rental device 100 of this disclosure only rents the car if the user meets the rentable requirements; and the customized requirements for renting cars include: (1) The user holds a valid local or international driver's license; (2) Only the payment made with a built-in credit card or stored-value wallet is accepted; (3) Transport of pets is allowed or prohibited; (4) No smoking or taking drugs is allowed during the rental period; (5) Prohibition of driving after drinking alcohol; (6) The car must be returned in a clean condition; (7) No overloading; (8) Prohibition of putting lighters and mineral water in the car.
5. Establishment of Rental Vehicle Network: The vehicle 1 established by the vehicle rentable and networkable module 2 of the diversified system sharing leasing device 100 of this disclosure can create the effect of a network sharer through vehicle network sharing and signal sharing, which allows the vehicle owner to use the network fee as another mean of income; it can also be applied to information transmission (such as serving as a mobile signal station in times of war to transmit war information, etc.)
6. Application of Internet of Vehicles: The vehicle 1 established by the vehicle rentable and networkable module 2 of the diversified system shared rental device 100 of this disclosure forms an Internet of Vehicles by installing a network device and a GPS positioning device to each of the vehicles 1, thus improving vehicle performance, safety and autopilot judgment capability, while creating a big data to improve traffic jam; and in the future, these data can be provided for the use by various vehicle manufacturers, or for the traffic light management optimization to improve traffic jam, efficient travel and safety on the road.
7. Digital Identity Authentication: The diversified system shared rental device 100 of this disclosure makes use of the blockchain decentralization to protect data from data tampering and establishes a digital identity authentication including but not limited to passports, driver's licenses, electronic identity data, etc. for blockchain users and vehicle owners, thus avoiding identity tampering, and applying the authentication to blockchain electronic airline ticket, customs clearance verification and other operations.
8. Application of Electronic Wallet Payment: The user vehicle unlock/use of the rental platform 3 of the diversified system shared rental device 100 of this disclosure uses a global blockchain wallet payment system including but not limited to QR code, barcode, and pay code to provide a cross-country wallet function and avoid the situation that the users are limited by cross-country credit card and payment.
9. Application of User Vehicle Unlock/Use: The aforementioned user vehicle unlock/use of the rental platform 3 of the diversified system shared rental device 100 in accordance with this disclosure can use the proximity sensing function including but not limited to NFC, Bluetooth, etc. of a user device (such as a mobile phone) to integrate the applications including but not limited to housing keys, car keys, amusement park tickets, exhibition tickets, restaurant reservation tickets, lecture tickets, concert tickets, airline tickets with the overall key integration application of the rental associated service.
10. Integration and Effect of New Technology in this Disclosure: The diversified system shared rental device 100 of this disclosure can be applied to the diversified system shared rental device 100 through new technologies including but not limited to metaverse, Web3.0, 6G, AR, VR, MR, LEO satellite communication technology, long-distance (such as sea vehicles, flying vehicles, etc.) communication and network relay technology, 3D, XR, multi-angle, virtual-reality integration, AI sensing, AI recognition, immersive experience, etc. It can be expanded to the applications of unmanned/manned couriers, vehicle retrieval and return, and user recognition to improve the efficiency and safety of the diversified system shared rental device 100 of this disclosure, and its implementation are as follows:
(10-1). Metaverse: Through virtual reality technology, users of the system can interact with other users and explore various scenes and environments in which the system is applied to build virtual worlds. These various scenes and environments include but are not limited to virtual displays of various vehicles, user interaction areas, etc., to create an immersive experience of vehicle exploration and user communication.
(10-2). Web3.0: The Web3.0 technology provides a more efficient and secure network environment, and it also provides decentralized storage of all user and vehicle information through the Web3.0 block chain technology to ensure the security of all data and provide the best decentralized system management.
(10-3). 6G: The 6G technology provides higher speed and more stable network connection. Therefore, when users of this system use the rental platform 3, the users can find vehicle information, make reservations and complete the rental process more quickly.
(10-4). AR/VR/MR: Through Augmented Reality (AR), Virtual Reality (VR) and Mixed Reality (MR) technologies, AR technology realizes real-time inspection of the carrier, VR technology provides a virtual test drive experience of the vehicles, and MR technology integrates the virtual vehicle with the real world to realize the entire virtual rental experience.
(10-5). LEO Satellite Communication Technology: Low Earth Orbit (LEO) satellite communication technology provides stable, high-speed network connectivity and enables more accurate positioning and navigation of vehicles and users, allowing users of this system to more accurately locate and reserve vehicles with a more secure rental experience.
(10-6). Telecommunication and Network Relay Technology: Through telecommunication and network relay, users of this system can conduct rental transactions regardless of location restrictions, including but not limited to mountains, oceans, and high altitude.
(10-7). 3D Technology: Through the 3D modeling technology, 3D models of vehicles can be built quickly and rendered and displayed in real time, so that users can know the size or usage of vehicles they need more intuitively.
(10-8). XR technology: Through the integration of Virtual Reality (VR), Augmented Reality (AR) and Mixed Reality (MR) technologies, users can experience the usage scenarios of all vehicles in a virtual environment to improve the matching of the subsequent real-world rental experience.
(10-9). AI Sensing Technology: Through machine learning and deep learning technology, objects can be detected, identified, managed and controlled. For example, unmanned/manned couriers can achieve automatic obstacle avoidance and path planning by the AI sensing technology to improve the efficiency and safety of transportation.
(10-10). AI Identification Technology: Customer management services can be realized through the identification of customer identity and behavior. For example, in the rental of cars (such as fuel cars, oil-electric vehicles, pure electric vehicles, etc.), and the AI identification technology can be used to verify the user's identity and driver's license to ensure the security and authenticity of user information.
(10-11). Immersive Experience Technology: Through VR, AR and other technologies, the immersive experience, such as virtual vehicle test rides, rental teaching, etc. can be achieved, so that users can truly experience all the effects of this disclosure provided to the user to improve the user experience.
11. Application of Sharing a Plurality of Digital Keys: The user vehicle unlock/use of the rental platform 3 of the diversified system shared rental device 100 of this disclosure can create digital keys by any of the aforementioned implementation methods (such as App, etc.), and can create a plurality of digital keys as needed, just like the effect of the primary key and secondary key of a general vehicle. The users can share the digital key with the target object through the rental platform 3 to enhance the convenience of rental. For example, the users can share the digital key with other users of the same vehicle and having the access to the rental platform 3, and the digital key will be automatically deactivated at the end of the rental.
12. This disclosure can update the remote vehicle service software by the networking of self-use vehicles to ensure that the latest service software is available for any vehicle.
13. In an embodiment of this disclosure, through a graphic code, SMS code, etc., a direct rental and a transfer of fees can be done directly to complete the unlocking of the vehicle to use the vehicle, thus avoiding vehicle control or unlocking errors.
14. In an embodiment of this disclosure, an electronic fence can be formed by the sensor to detect a certain range of vehicles, and the user can sense and receive the receipt to unlock the vehicle for use, and prevent robbery, prank and other unwanted situations.
15. This disclosure can control any vehicle, and set the travel path and height range for any vehicle, and any vehicle can be detected and controlled through the communication system layout.

The technical characteristics of this disclosure are described below:
1. This disclosure is applicable to any vehicle: vehicle including but not limited to car (such as original car, hybrid car, electric car, etc.), motorcycle, bicycle, airplane, ship/boat, public transportation (such as bus, subway, tram, etc.), personal transportation means (such as wheelchair, scooter, skateboard, etc.), transportation means (such as trailer, truck, etc.), unmanned vehicle (such as auto-driving car, drone, etc.), railway transportation (such as train/high-speed rail/subway, etc.)
2. Self-use vehicles can be made rentable and networkable: By installing equipment including but not limited to network, connection, sensor, camera for scanning barcodes and QR codes, and monitoring equipment on the vehicles, and completing the connection with the diversified system shared rental device 100, we can establish the self-use vehicle that can be rented and networked.
3. Rental Platform: Through a variety of implementation methods, users can rent a vehicle through the rental platform, and the owner of the vehicle can also confirm the acceptance of the user's rental through the rental platform to complete the rental matchmaking operation.
4. Matching of Designated Drivers: Users are provided with advance booking or instant matching of designated drivers.
5. Anti-tampering Mechanism: The user takes photos around the vehicle to record the condition of the vehicle before the diversified system shared rental device 100 provides the rental service (unlocking the vehicle), so that there is evidence for the attribution of responsibility in the event of disputes. At the same time, the system is set up to avoid taking pre-recorded photos, and users must take photos of the vehicles on site to avoid alteration problems.

Compared with the prior art, this disclosure has the following advantages:

The issues in the traditional/prior-art vehicle rental market are as follows:
1. The traditional rental market such as iRent in Taiwan needs to invest heavy investiment to buy cars, and replace the cars every 10 years, thus incurring higher costs and risks.
2. The traditional rental market around the world requires cumbersome document verification and delivery procedures, and users have to spend a lot of time waiting.
3. The traditional rental market such as iRent in Taiwan cannot solve the problems of car cleanliness, the inspection of engine oil, automatic transmission fluid, power steering fluid, brake fluid, gasoline, and water in water tank, battery, and windshield wiper, tire pressure safety, etc., which affect the user's experience and safety of driving.

With the following methods, this disclosure can solve the aforementioned problems:
1. Unlike shared rental, this system turns a self-use car into a rentable state. Therefore, this system does not require a large amount of capital to buy the cars, but rather cooperates with anyone in the world who owns a car, thus increasing the income of families and individuals, making the vehicle no longer a negative asset, and realizing a profit.
2. The system allows users to rent a car anywhere in the world without the hassle of handing over the car by using a real name system, but simply needs the user to upload a driver's license with a credit card.
3. With the instructions of this system, all car cleaning and inspection are the sole responsibility of the car renter and the sensed data are confirmed by the system, so that there is no need to hire additional personnel to handle these operations, so as to reduce the operating expenses of the diversified system shared rental device.
4. By a device including but not limited to SIM card and control chip, this system can make all vehicles, regardless of their form, into a rentable and networkable state.

In addition, the diversified system shared rental device 100 of this disclosure further creates the following beneficial effects: (1) The car renter of the diversified system shared rental device 100 of this disclosure can effectively increase the utilization of the car, reduce idle waste, and at the same time bring additional income to individuals or families; (2) Through the rental data, vehicle operation efficiency can be obtained, vehicle use plans can be optimized, revenue efficiency can be improved, and more accurate market analysis and decision basis can be provided to vehicle owners.

The shared rental system for any vehicle of this disclosure includes the vehicle 1, the vehicle rentable and networkable module 2 and the diversified system shared rental device 100; and the shared rental method includes the steps of: (S1) making a vehicle rental request by a user; (S2) entering into a diversified system shared rental device; (S3) screening a suitable vehicle by the diversified system shared rental device or inquiring and selecting a suitable vehicle by a customer; (S4) completing the pairing of a rentable vehicle; and the vehicle rentable and networkable module 2 is provided to create the vehicle 1 with the rental capability, and the diversified system shared rental device 100 accesses the vehicle rentable and networkable module 2 to connect and link the vehicle 1 that can be rented and networked. The rental platform 3 is provided to complete the rental match and provide control, dispatch, operation and management of the rental of the vehicle 1. The diversified system shared rental device 100 is provided to display the suitable vehicle 1 through at least one rental platform 3 for the user to complete the pairing and use the rental service for any of the vehicles 1. This disclosure turns a self-use vehicle 1 into a vehicle that can be rented and networked, and allows users to rent the vehicle 1 through the rental platform 3. The owner of the vehicle 1 can also confirm the acceptance of the user's rental request through the rental platform 3, so as to complete the rental matching operation, and provide users advance booking of a vehicle or instant matching of a designated driver. The user has to take a photo around the vehicle to record the vehicle condition before the diversified system shared rental device will provide the rental service (or unlock the vehicle). This disclosure effectively improves the convenience of use and provides rental and sharing of people's self-use vehicles at any time in their free time, minimizing the idle cost of all vehicles, and establishing a profit model for the self-use vehicles. Obviously, the present disclosure significantly expands the industrial utilization and is novel and inventive.

In summation of the description above, this disclosure breaks through the related art and definitely achieves the desired improvement, and the disclosure is non-obvious, novel, and inventive, and complies with the patent application requirements, and thus is duly filed for patent application.

While the disclosure has been described by means of specific embodiments, it is to be understood that the disclosure is not limited thereto. To the contrary, numerous modifications and variations could be made thereto by those skilled in the art without departing from the scope and spirit of the disclosure set forth in the claims.

What is claimed is:

1. A diversified system shared rental device, characterized in that the diversified system shared rental device, comprises:
a plurality of vehicles;
a vehicle rentable and networkable module, coupled to the vehicles; and
a rental platform, coupled to a vehicle rentable and networkable module and the vehicles, and provided for a user to use the service of the diversified system shared rental device; while a vehicle owner can confirm and accept the user's rental through the rental platform to complete a rental matching operation;
thereby, the vehicle rentable and networkable module displays a suitable vehicle through the rental platform for the user to complete pairing and using the rental service.

2. The diversified system shared rental device according to claim 1, wherein the diversified system shared rental device establishes the vehicles with a rental capability through the vehicle rentable and networkable module, and provides a rental control of the vehicle by linking and connecting the rentable and networked vehicle obtained through the vehicle rentable and networked module to complete the rental matching through the rental platform and provide the rental control, distribution, operation and management of the vehicle.

3. The diversified system shared rental device according to claim 1, wherein the diversified system shared rental device is completed through a user photographing the surrounding of the vehicle and recording the vehicle conditions before the diversified system shared rental device can provide rental service and unlock the vehicle, so as to provide evidence to attribute responsibility when there is a dispute, and at the same time through the system settings, to avoid pre-photographing or pre-recording, and user must photograph the vehicle at the scene to avoid falsification.

4. A diversified system shared rental method, characterized in that a diversified system shared rental device comprises a plurality of vehicles, a vehicle rentable and networkable module and a rental platform for carrying out the diversified system shared rental method, comprising the steps of:
(1) making a vehicle rental request by a user;
(2) entering into the diversified system shared rental device;
(3) screening a suitable vehicle by the diversified system shared rental device or inquiring and selecting a suitable vehicle by a customer; and
(4) completing the pairing of a rentable vehicle.

5. The diversified system shared rental method according to claim 4, wherein the vehicle achieves the rentable and networked method, comprising the steps of:
(1) installing an equipment including but not limited to networking, online, sensing, scanning barcode and QR code camera equipment, and monitoring equipment to the vehicle; and
(2) connecting the equipment installed to the vehicle with the diversified system shared rental device to complete a link; such that the vehicle can be rented and networked with a control means.

6. The diversified system shared rental method according to claim 5, wherein the vehicle is turned into a rentable and networked vehicle by the car rentable and networked module by the method comprising the steps of:
(1) equipping the vehicle with an NFC-sensitive, network-capable chip or device, and a camera device that can scan any barcode and QR code; and
(2) connecting the equipment installed on the vehicle to the diversified system shared rental device to complete a link;
such that a renter can obtain the operation functions of the vehicle including but not limited to unlocking, opening the lock, and starting the vehicle by scanning the barcode and QR code, and by connecting to the diversified system shared rental device through the network, so that the diversified system shared rental device has a control means to control the rental vehicle, and the vehicle can be rented and networked.

7. The diversified system shared rental method according to claim 4, wherein, the diversified system shared rental device manages all rentable vehicles, including but not limited to repair/maintenance management, violation management, insurance management, positioning management, accident management, evaluation management, dispatch management, recovery management, and reminder management.

8. The diversified system shared rental method according to claim 4, wherein the rental platform provides a login means to the user or the vehicle owner, and the service usage and account creation method include username and password, social media communication software login, email verification code, SMS verification code, fingerprint recognition, face recognition, retina recognition or voice recognition; and the user provides information including but not limited to mobile phone number, email, identity information (such as identity card, passport, driver's license, international driver's license), payment method (such as global credit card, electronic payment, third-party payment, etc.), in order to avoid data tampering by blockchaining technology, create the user's digital identity authentication, and complete registering an account to use the rental platform.

9. The diversified system shared rental method according to claim 4, wherein the rental platform assists the user to rent a vehicle and the vehicle owner to use the associated service for renting out a vehicle through the following features/functions including but not limited to registration and authentication, car search and reservation, user vehicle unlock/use, pricing method, payment, order management, socialization and promotion, wallet and vehicle owner management assistance.

10. The diversified system shared rental method according to claim 4, wherein the diversified system shared rental device is an unmanned diversified system shared rental device, which is a rental method based on an unmanned driving technology, and the diversified system shared rental device allows the user to reserve an unmanned vehicle and complete the operation of picking up, returning and driving the vehicle through the unmanned driving technology.

11. The diversified system shared rental method according to claim 4, wherein the vehicles established by the vehicle rentable and networkable module of the diversified system shared rental device form an Internet of Vehicles by means of installing a network device and a GPS device to each of the vehicles to improve vehicle performance, safety and autopilot judgment capability, while creating a big data to improve traffic jam; and in the future, these data can be provided for the use by various vehicle manufacturers, or for the traffic light management optimization to improve traffic jam, efficient travel and safety on the road.

12. The diversified system shared rental method according to claim 4, wherein the diversified system shared rental device protects data by blockchain decentralization to prevent data tampering and establish a digital identity authentication; and provides blockchain users and vehicle owners an identity documentation including but not limited to a passport, a driver's license, an electronic identity information, etc. to avoid identity tampering, which can also be applied for operations such as the verification of a blockchain airline ticket for immigration and customs clearance.

13. The diversified system shared rental method according to claim 9, wherein the rental platform of the diversified system shared rental device can apply a user vehicle unlock/use to a proximity sensing function including but not limited to NFC, Bluetooth, etc. through a user device (such as mobile phone) for an application including but not limited to housing keys, car keys, amusement park tickets, exhibition tickets, restaurant reservation tickets, lecture tickets, concert tickets, and airline tickets, and integrates the rental with an overall key integrated application of an associated service.

14. The diversified system shared rental method according to claim 4, wherein the diversified system shared rental device is provided for rental and unlocked after the user takes the photo of the surrounding of the vehicle, records the condition of the vehicle to provide evidence for attribution of liability in the event of a dispute, and avoid the problem of alteration through the system configuration and the user must takes the photo of the vehicle on site to prevent pre-photographing or pre-videorecording.
